(19) United States
(12) Patent Application Publication
(10) Pub. No.: US 2013/0342061 A1
(43) Pub. Date: Dec. 26, 2013

(54) SPINDLE MOTOR

(71) Applicant: Hyun Ho SHIN, Suwon (KR)

(72) Inventor: Hyun Ho SHIN, Suwon (KR)

(73) Assignee: SAMSUNG ELECTRO-MECHANICS CO., LTD., Suwon (KR)

(21) Appl. No.: 13/595,067

(22) Filed: Aug. 27, 2012

(30) Foreign Application Priority Data
Jun. 25, 2012 (KR) 10-2012-0067872

(51) Int. Cl. H02K 7/08

(52) U.S. Cl. 310/90

(57) ABSTRACT

There is provided a spindle motor including a lower thrust member fixed to a base member; a shaft having a lower end portion fixed to the lower thrust member; a rotating member rotating around the shaft; an upper thrust member fixed to an upper end portion of the shaft and forming a bearing clearance together with the rotating member; and a cover member fixed to the upper thrust member.

### CROSS-REFERENCE TO RELATED APPLICATIONS

This application claims the priority of Korean Patent Application No. 10-2012-0067872 filed on Jun. 25, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A fixed-shaft type spindle motor in which a shaft having strong impact resistance is fixed to a box of a hard disk driving device may be mounted in an information recording and reproducing device such as a hard disk driving device, or the like.

That is, the shaft may be fixedly installed in the spindle motor mounted in the hard disk driving device in order to prevent information recorded in the server from being damaged and unrecordable/unreadable due to external impact.

Meanwhile, in accordance with the trend toward slimness of electronic devices using the hard disk driving device, thinness of the spindle motor as well as the hard disk driving device has been demanded.

In order to satisfy this demand of the, the spindle motor may be thinned by reducing an interval between grooves provided in the spindle motor, that is, a length of a dynamic pressure part.

However, when the length of the dynamic pressure part is reduced as described above, rotation characteristics may be deteriorated. That is, a length of a bearing span is reduced, such that rotation characteristics of a rotor may be deteriorated.

Therefore, the development of a structure in which the thinness of the spindle motor may be implemented without reducing the length of the dynamic pressure part, in other words, without reducing the length of the span has been demanded.

### [Related Art Document]

(Patent Document 1) Japanese Patent Laid-open Publication No. 2011-12737

### SUMMARY OF THE INVENTION

An aspect of the present invention provides a spindle motor capable of being thinned.

According to an aspect of the present invention, there is provided a spindle motor including: a lower thrust member fixed to a base member; a shaft having a lower end portion fixed to the lower thrust member; a rotating member rotating around the shaft; an upper thrust member fixed to an upper end portion of the shaft and forming a bearing clearance together with the rotating member; and a cover member fixed to the upper thrust member.

The upper thrust member may have a coupling part inserted into an installation hole of the cover member.

The upper thrust member may have a support surface supporting a lower surface of the cover member disposed around the installation hole.

The support surface may be provided with an adhesive receiving groove receiving an adhesive therein.

The upper thrust member may have an extension part inserted in insertion groove formed in the rotating member.

At least one of an inner wall part of the insertion groove and an inner peripheral surface of the extension part may be inclined so as to form an interface between a lubricating fluid filled in the bearing clearance and air.

The spindle motor may further include a clamping member installed on an outer peripheral surface of the rotating member to allow for fixation of a disk.

The upper thrust member may have a seating groove formed in an upper end portion thereof, the seating groove having a protrusion seated thereon and extended inwardly of the installation hole of the cover member.

The protrusion may include a plurality of protrusions disposed to be spaced apart from each other in a circumferential direction.

The rotating member may include: a sleeve forming a bearing clearance together with the shaft and the upper and lower thrust member; and a rotor hub extended from the sleeve, wherein the sleeve and the rotor hub are formed integrally with each other or separately formed and then coupled to each other.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of the part A of FIG. 1;

FIG. 3 is a cut-away perspective view showing a upper thrust member and a cover member included in the spindle motor according to the embodiment of the present invention;

FIG. 4 is a schematic cross-sectional view showing a spindle motor according to another embodiment of the present invention;

FIG. 5 is an enlarged view showing the part B of FIG. 4; and

FIG. 6 is a plan view showing the spindle motor according to another embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

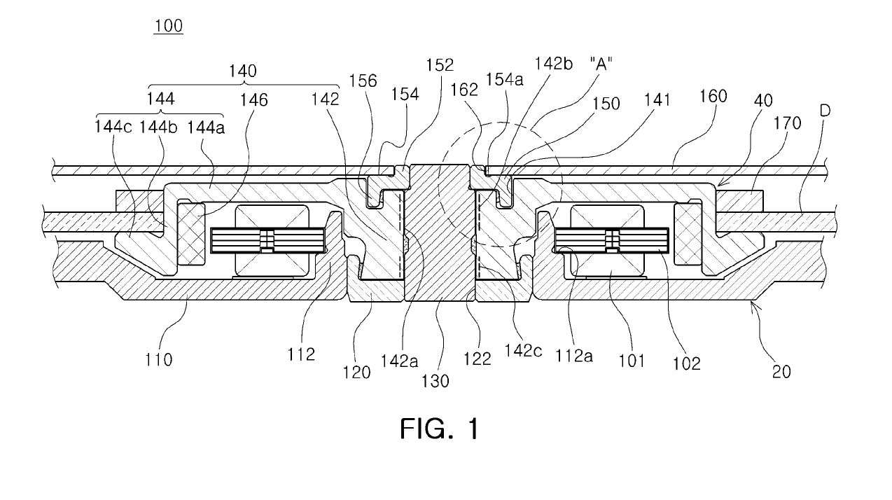

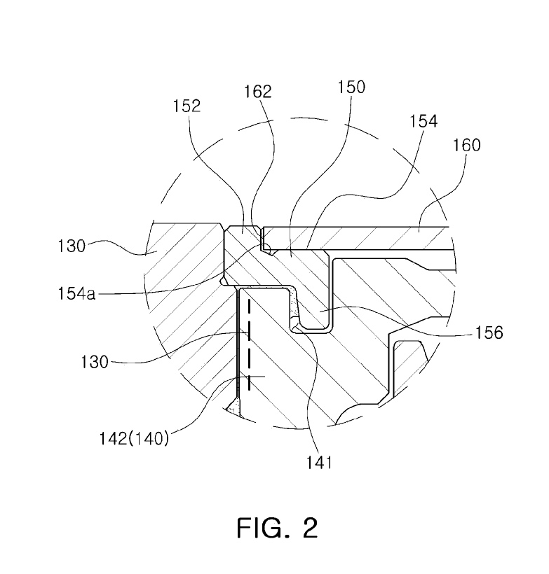

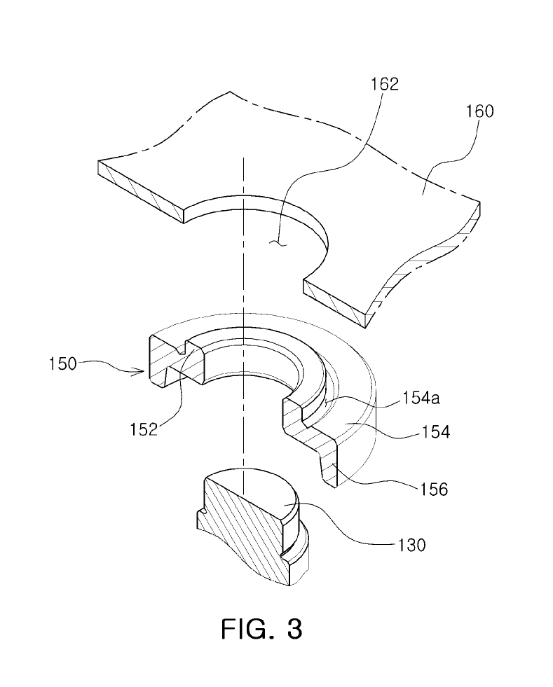

FIG. 1 is a schematic cross-sectional view showing a spindle motor according to an embodiment of the present invention; FIG. 2 is an enlarged view of the part A of FIG. 1; and FIG. 3 is a cut-away perspective view showing a upper thrust member and a cover member included in the spindle motor according to the embodiment of the present invention.

Referring to FIGS. 1 through 3, a spindle motor 100 according to the embodiment of the present invention may include a base member 110, a lower thrust member 120, a shaft 130, a rotating member 140, an upper thrust member 150, a cover member 160, and a clamping member 170 by way of example.

Meanwhile, the spindle motor 100 according to the embodiment of the present invention may be a motor used in an information recording and reproducing device such as a hard disk driving device, or the like.

In addition, the spindle motor 100 according to the embodiment of the present invention may be mainly configured of a stator 20 and a rotor 40.

The stator 20 may refer to which means all fixed members with the exception of rotating members and include the base member 110, the lower thrust member 120, the shaft 130, the upper thrust plate 150, the cover member 160, and the like.

In addition, the rotor 40 may refer to members rotating around the shaft 130 and include the rotating member 140, and the like.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, and a radial direction refers to a horizontal direction, that is, a direction from the shaft 130 toward an outer peripheral surface of the rotating member 140 or from the outer peripheral surface of the rotating member 140 toward the shaft 130.

In addition, a circumferential direction refers to a rotation direction along the outer peripheral surface of the rotating member 140.

The base member 110 may be a fixed member included in the stator 20 rotatably supporting the rotor 40. In addition, the base member 110 may have a protrusion part 112 extended upwardly in the axial direction.

Meanwhile, the protrusion part 112 may have a stator core 102 fixedly installed on an outer peripheral surface thereof. To this end, the protrusion part 112 may be provided with a seating surface 112a on which the stator core 104 is seated.

In addition, the base member 110 may also be manufactured by die-casting using an aluminum (Al) material. Alternatively, the base member 110 may also be molded by performing plastic processing (for example, press working) on a steel plate.

The lower thrust member 120 may be included together with the base member 110 in the fixed member, that is, the stator 20, and be fixed to the base member 110. That is, the lower thrust member 120 may be inserted in the protrusion part 112. More specifically, the lower thrust member 120 may be installed such that an outer peripheral surface thereof is bonded to an inner peripheral surface of the protrusion part 112.

In addition, the outer peripheral surface of the lower thrust member 120 may be bonded to an inner surface of the base member 110 by an adhesive and/or welding. In other words, the outer peripheral surface of the lower thrust member 120 may be fixedly bonded to an inner surface of the protrusion part 112 of the base member 110.

Meanwhile, the lower thrust member 120 may have an inner surface bonded to the shaft 130 and an outer surface fixed to the base member 110.

To this end, the lower thrust member 120 may have a mounting hole 122 formed therein in order to install the shaft 130 thereon, such that the shaft 130 has a lower end portion insertedly mounted in the mounting hole 122.

In addition, the lower thrust member 120 may have a hollow cup shape and may have an ‘L’ shaped cross section.

Meanwhile, a thrust dynamic pressure groove (not shown) for generating thrust fluid dynamic pressure may be formed in at least one of an upper surface of the lower thrust member 120 and a surface of the rotating member 140 disposed so as to face the upper surface of the lower thrust member 120.

Further, the lower thrust member 120 may also serve as a sealing member for preventing a lubricating fluid from being leaked.

The shaft 130, which is a fixed member configuring the stator 20 together with the base member 110, may have the lower end portion fixed to the lower thrust member 120. That is, as described above, the lower end portion of the shaft 130 may be installed so as to be inserted into the mounting hole 122 of the lower thrust member 120.

In addition, the lower end portion of the shaft 130 may be bonded to the inner surface of the lower thrust member 120 by an adhesive and/or welding. Therefore, the shaft 130 may be fixed to the lower thrust member 120.

Although the present embodiment describes a case in which the shaft 130 is fixed to the lower thrust member 120, the present invention is not limited thereto. That is, the shaft 130 may also be fixed to the base member 110.

The rotating member 140, which is a rotating member rotating around the shaft 130, may be included in the rotor 40.

In addition, the rotating member 140 may include a sleeve 142 forming a bearing clearance in which a lubricating fluid is filled, together with the upper and lower thrust members 150 and 120 and the shaft 130, and a rotor hub 144 extended from the sleeve 142 and having a disk D mounted thereon.

In addition, the sleeve 142 and the rotor hub 144 may be formed integrally with each other. However, the present invention is not limited thereto. That is, the sleeve 142 and the rotor hub 144 may also be separately manufactured and then coupled to each other.

Meanwhile, the sleeve 142 may be provided with a shaft hole 142a in which the shaft 130 is inserted. In the case in which the rotating member 140 is installed to the shaft 130, an inner peripheral surface of the sleeve 142 and an outer peripheral surface of the shaft 130 may be spaced apart from each other by a predetermined interval to form a bearing clearance.

This bearing clearance may be filled with the lubricating fluid.

Meanwhile, upper and lower radial dynamic pressure grooves 142b and 142c may be formed in at least one of the inner peripheral surface of the sleeve 142 and the outer peripheral surface of the shaft 130, in order to generate fluid dynamic pressure by pumping the lubricating fluid at the time of rotation of the rotating member 14.

In addition, regions at which maximum pressure is generated by the upper and lower radial dynamic pressure grooves 142b and 142c needs to be spaced apart from each other by a predetermined distance in order to obtain more stable rotation characteristic of the rotating member 140.

When the region in which the upper and lower radial dynamic pressure grooves 142b and 142c are formed is reduced in order to implement thinness, the rotation characteristics of the rotating member 140 may be deteriorated. In other words, in the case in which the region in which the inner peripheral surface of the sleeve 142 and the outer peripheral surface of the shaft 130 are disposed to face each other is reduced, the rotation characteristics of the rotating member 140 may be deteriorated.

Further, the sleeve 142 may have inclined surfaces formed on upper and lower end portions of the outer peripheral surface thereof in order to form a liquid-vapor interface together with the upper and lower thrust members 150 and 120.

The rotor hub 144 may be extended from the upper end portion of the sleeve 142 in the radial direction. In addition, the rotor hub 144 may include a rotor hub body 144a having a disk shape, a magnet mounting part 144b extended from an edge of the rotor hub body 144a and having a driving magnet 146 mounted on an inner surface thereof, and a disk seating part 144c extended outwardly in the radial direction from a distal end of the magnet mounting part 144a.

Meanwhile, the driving magnet 146 may have an annular ring shape and may be a permanent magnet generating a magnetic field having a predetermined strength by alternately magnetizing an N pole and an S pole in the circumferential direction.

In addition, the driving magnet 146 may be disposed to face a front end of the stator core 102 having a coil 101 wound therearound and may generate driving force due to electromagnetic interaction with the stator core 102 having the coil 101 wound therearound such that the rotating member 140 may rotate.

That is, when power is supplied to the coil 101, the driving force rotating the rotating member 140 is generated due to the electromagnetic interaction between the stator core 102 having the coil 101 wound therearound and the driving magnet 146 disposed to face the stator core 102, such that the rotating member 140 may rotate around the shaft 130.

The upper thrust member 150 may be fixed to an upper end portion of the shaft 130 to from the bearing clearance together with the sleeve 140.

Meanwhile, the upper thrust member 150 may have a coupling part 152 inserted into an installation hole 162 of the cover member 160. That is, in the case in which the cover member 160 is coupled to the upper thrust member 150, the coupling part 152 may be inserted into the installation hole 162 of the upper thrust member 150. In this case, an outer peripheral surface of the coupling part 152 may contact an inner peripheral surface of the upper thrust member 150, in which the installation hole 162 is formed.

In addition, the upper thrust member 150 may have a support surface 154 supporting a lower surface of the cover member 160 disposed around the installation hole 162. That is, in the case in which the coupling member 152 of the upper thrust member 150 is inserted into the installation hole 162, the lower surface of the cover member 160 disposed around the installation hole 162 may be supported by the support surface 154.

Therefore, a contact area between the upper thrust member 150 and the cover member 160 increases, such that coupling force between the upper thrust member 150 and the cover member 160 may increase.

Meanwhile, the support surface 154 may be provided with an adhesive receiving groove 154 receiving an adhesive therein.

Here, a coupling method between the upper thrust member 150 and the cover member 160 will be briefly described. The adhesive may be applied to the outer peripheral surface of the coupling part 152 of the upper thrust member 150 and the support surface 154, and the cover member 160 and the upper thrust member 150 may be then coupled to each other such that the coupling part 152 is inserted into the installation hole 162 of the cover member 160.

Therefore, the cover member 160 and the upper thrust member 150 may be bonded to each other through the adhesive. In addition, two surfaces of the cover member 160 contact two surfaces of the upper thrust member 150 corresponding thereto, such that coupling force therebetween may increase.

Meanwhile, since the adhesive receiving groove 154 is formed in the support surface 154, the coupling force between the cover member 160 and the upper thrust member 150 may further increase by the adhesive received in the adhesive receiving groove 154a.

Although the case in which the upper thrust member 150 and the cover member 160 are coupled to each other through the adhesive is described by way of example in the present embodiment, the present invention is not limited thereto. That is, the upper thrust member 150 and the cover member 160 may also be coupled to each other by any one of an adhesion method, a press-fitting method, and a welding method.

In addition, the upper thrust member 150 may have an extension part 156 insertedly disposed in an insertion groove 141 formed in the rotating member 140.

The extension part 156 may serve to form a liquid-vapor interface together with an upper end portion of an outer peripheral surface of the sleeve 142 of the rotating member 140.

Meanwhile, the extension part 156 is inserted in the insertion groove 141, such that a labyrinth seal is formed by an outer peripheral surface of the extension part 156 and an outer wall part forming the insertion groove 141, whereby evaporation of the lubricating fluid may be suppressed.

Meanwhile, an inner wall part forming the insertion groove 141, in other words, the upper end portion of the outer peripheral surface of the sleeve 142 may be inclined such that an interface between the lubricating fluid filled in the bearing clearance and air is formed.

The cover member 160 may be fixed to the upper thrust member 150. The cover member 160 may form a housing for a recording disk driving device (not shown) together with the base member 110. That is, the cover member 160 and the base member 110 may be coupled to each other so as to have an internal space therebetween, thereby forming an appearance of the recording disk driving device.

In addition, the cover member 160 may have the installation hole 162 as described above to which the coupling part 152 of the upper thrust member 150 is insertedly coupled.

As described above, the cover member 160 is coupled to the upper thrust member 150, whereby an increase in a thickness of the spindle motor 100 due to the cover member 160 may be reduced. That is, the increase in the thickness of the spindle motor 100 due to the cover member 160 may be reduced as compared to a case in which the cover member 160 is screwed to the shaft 130.

Therefore, as described above, the increase in the thickness of the spindle motor due to the cover member 160 may be prevented without reducing the region in which the upper and lower radial dynamic pressure grooves 142b and 142c are formed, whereby the spindle motor may be thinned.

The clamping member 170 may be installed on the outer peripheral surface of the rotating member 140 to allow for the fixation of the disk D. That is, the clamping member 170 may be fixedly installed on an outer peripheral surface of the magnet mounting part 144b to press an upper surface of the disk D.

As described above, since the clamping member 170 is fixedly installed on the outer peripheral surface of the magnet mounting part 144b, an increase in a thickness of the spindle motor due to the clamping member 170 may also be prevented, as compared to the case in which the clamping member 170 is installed on an upper surface of the rotor hub body 144a.

Therefore, the spindle motor 100 may be further thinned.

Meanwhile, the clamping member 170 may be installed on the outer peripheral surface of the magnet mounting part 144b by various methods. For example, screw parts are formed on the clamping member 170 and the outer peripheral surface of the magnet mounting part 144b, respectively, such that the clamping member 170 may be screwed with the magnet mounting part 144b. In addition, the clamping member 170 may also be installed on the outer peripheral surface of the magnet mounting part 144b by a press-fitting method.

As described above, since the cover member 160 is installed on the upper thrust member 150, the increase in the thickness of the spindle motor due to the cover member 160 is reduced, whereby the spindle motor may be thinned. In addition, since the spindle motor may be thinned without reducing a distance (that is, a span length) of the region in which the maximum pressure is generated by the upper and lower radial dynamic pressure grooves 142b and 142c, deterioration in the rotation characteristics may be prevented.

In addition, the clamping member 170 is installed on the outer peripheral surface of the magnet mounting part 144b, such that the increase in the thickness of the spindle motor due to the clamping member 170 is prevented, whereby the spindle motor 100 may be further thinned.

Hereinafter, a spindle motor according to another embodiment of the present invention will be described with reference to the accompanying drawings. However, the same components as the above-mentioned components will be denoted by the same reference numerals and a detailed description thereof will be omitted.

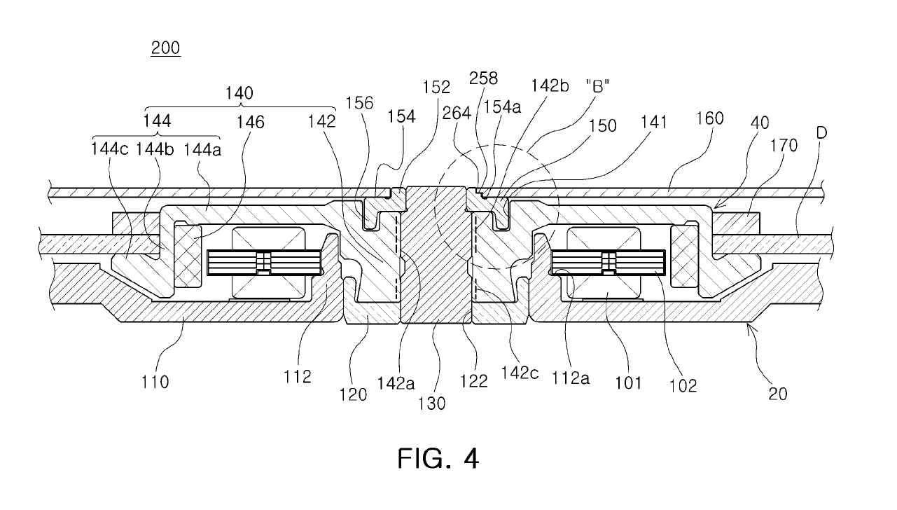

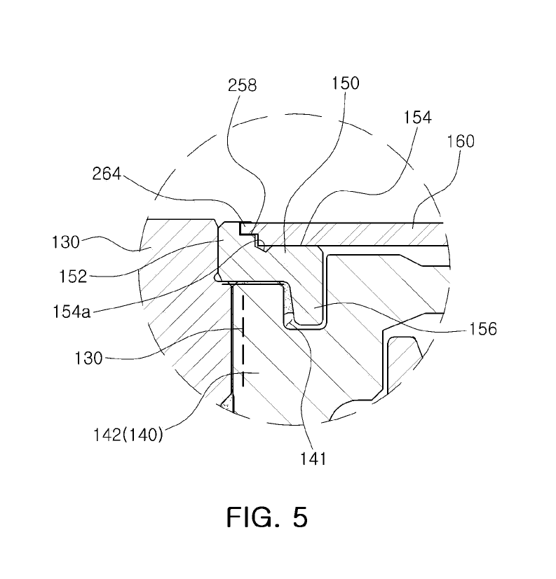

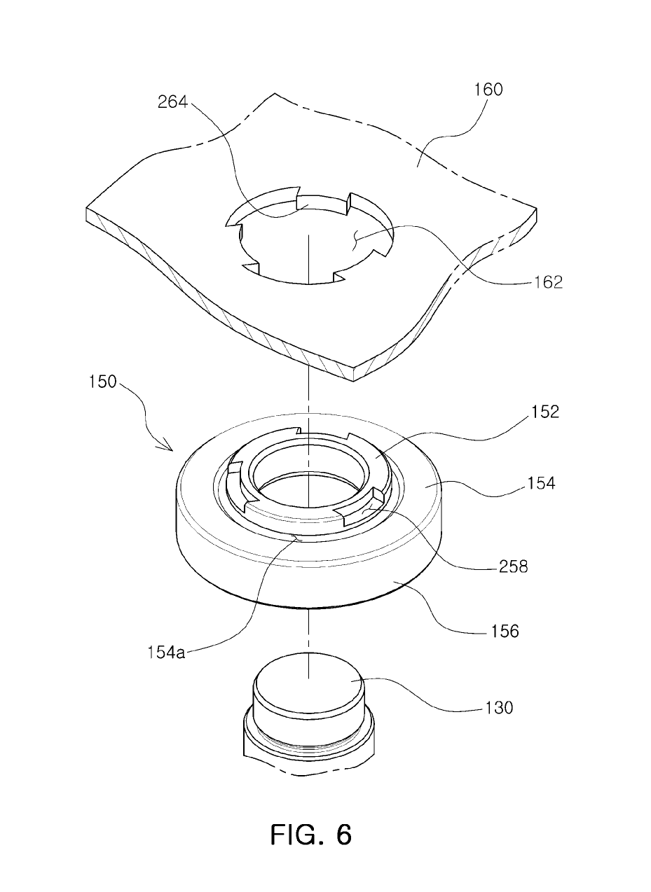

FIG. 4 is a schematic cross-sectional view showing a spindle motor according to another embodiment of the present invention; FIG. 5 is an enlarged view showing part B of FIG. 4; and FIG. 6 is a plan view showing the spindle motor according to another embodiment of the present invention.

Referring to FIGS. 4 through 6, the spindle motor 200 according to another embodiment of the present invention has the same configuration as that of the spindle motor 100 according to the embodiment of the present invention described above except that a seating groove 258 is formed in the upper thrust member 150 and a protrusion 264 is formed on the cover member 160 in the spindle motor 100 according to the embodiment of the present invention described above.

Hereinafter, the seating groove 258 of the upper thrust member 150 and the protrusion 264 of the cover member 160 will be described.

The upper thrust member 150 may have the seating groove 258 formed in an upper end portion thereof, wherein the seating groove 258 has the protrusion 265 seated thereon and extended inwardly of the installation hole 162 of the cover member 160.

The seating grooves 258 may be depressed from an upper surface of the coupling part 152 and have the same shape and the number as those of the protrusions 264.

Meanwhile, the protrusion 264 may be provided in plural and the plurality of protrusions 264 may be disposed to be spaced apart from each other in the circumferential direction. That is, the protrusion may be formed to increase a contact area between the upper thrust member 150 and the cover member 160, thereby increasing coupling force between the upper thrust member 150 and the cover member 160.

As described above, the protrusion 264 provided on the cover member 160 is inserted in the seating groove 258 of the upper thrust member 150, whereby the coupling force between the upper thrust member 150 and the cover member 160 may be further increased.

As set forth above, according to the embodiment of the present invention, the cover member is installed on the upper thrust member, such that the increase in the thickness of the spindle motor due to the cover member could be reduced to realize the thinning of the spindle motor.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a lower thrust member fixed to a base member;
a shaft having a lower end portion fixed to the lower thrust member;
a rotating member rotating around the shaft;
an upper thrust member fixed to an upper end portion of the shaft and forming a bearing clearance together with the rotating member; and
a cover member fixed to the upper thrust member.

2. The spindle motor of claim 1, wherein the upper thrust member has a coupling part inserted into an installation hole of the cover member.

3. The spindle motor of claim 2, wherein the upper thrust member has a support surface supporting a lower surface of the cover member disposed around the installation hole.

4. The spindle motor of claim 3, wherein the support surface is provided with an adhesive receiving groove receiving an adhesive therein.

5. The spindle motor of claim 2, wherein the upper thrust member has an extension part inserted in insertion groove formed in the rotating member.

6. The spindle motor of claim 5, wherein at least one of an inner wall part of the insertion groove and an inner peripheral surface of the extension part is inclined so as to form an interface between a lubricating fluid filled in the bearing clearance and air.

7. The spindle motor of claim 2, wherein the upper thrust member has a seating groove formed in an upper end portion thereof, the seating groove having a protrusion seated thereon and extended inwardly of the installation hole of the cover member.

8. The spindle motor of claim 7, wherein the protrusion includes a plurality of protrusions disposed to be spaced apart from each other in a circumferential direction.

9. The spindle motor of claim 1, further comprising a clamping member installed on an outer peripheral surface of the rotating member to allow for fixation of a disk.

10. The spindle motor of claim 1, wherein the rotating member includes:
a sleeve forming a bearing clearance together with the shaft and the upper and lower thrust member; and
a rotor hub extended from the sleeve,
wherein the sleeve and the rotor hub are formed integrally with each other or separately formed and then coupled to each other.

11. A spindle motor comprising:
a lower thrust member fixed to a base member;
a shaft having a lower end portion fixed to the lower thrust member;
a rotating member rotating around the shaft;
an upper thrust member fixed to an upper end portion of the shaft and forming a bearing clearance together with the rotating member; and
a cover member fixed to the upper thrust member,
wherein the upper thrust member has a coupling part inserted into an installation hole of the cover member and a support surface supporting a lower surface of the cover member disposed around the installation hole.
